(19) United States
(12) Patent Application Publication
(10) Pub. No.: US 2014/0319773 A1
(43) Pub. Date: Oct. 30, 2014

(54) ROTARY SEAL DEVICE

(71) Applicant: Crosby HOFF, Huntersville, NC (US)

(72) Inventor: Crosby HOFF, Huntersville, NC (US)

(21) Appl. No.: 13/871,039

(22) Filed: Apr. 26, 2013

(51) Int. Cl. F16J 15/32; F16J 15/16

(52) U.S. Cl. CPC F16J 15/3232; F16J 15/16
USPC 277/309; 277/300; 277/500; 277/549

(57) ABSTRACT

A shaft sealing assembly for creating a seal between a shaft and a stationary housing comprising: the shaft sealing assembly including a case and a sealing assembly within the case; the case having an inner seal surface diameter within which the shaft is located and within which the sealing assembly located; the case having an outside diameter which may be engaged to the stationary housing; the sealing assembly having an inner seal circumferential surface and an outer seal circumferential surface with the inner seal circumferential surface being engaged to a circumferential surface of the shaft, wherein the sealing assembly remains stationary on the shaft and the outer seal circumferential surface being slidably engaged to the inner seal surface diameter of the case.

### FIELD OF THE INVENTION

A rotary seal designed for use in sealing a rotary shaft.

### BACKGROUND OF THE INVENTION

Seals which are designed to fit around a sliding or rotating shaft have been used for decades. These rotary seals are used on a wide range of devices and machinery for a variety of reasons. The devices include, but are not limited to, electrical generators, turbines, and nearly any device which utilized a rotating shaft. Traditional rotary seals are employed for reasons which include, but are not limited to, contaminant exclusion, grease retention, oil retention, gas retention and bearing protection. Some specialty seals even combine those functions in order to both retain a gas, liquid or semi-solid material and to exclude a gas, liquid, semi-solid or other unwanted contaminant.

One of the most important features of any device which utilizes a rotating shaft in its design is a bearing. Bearings allow the shaft to rotate smoothly and efficiently. However, bearings must be kept clean and free of contaminants in order to maintain efficient function. A bearing which fails to operate efficiently may result in damage to the rotating shaft, or the bearing may fail partially or completely necessitating its replacement. The downtime due to premature bearing failure results in lost production and an increase in maintenance and operating costs.

Radial sealing assemblies function in a variety of ways to protect machine parts, including bearings. At a fundamental level, a sealing assembly is a barrier which functions to retain lubricants and/or other fluids, exclude contaminants, keep fluids separated, retain gasses and maintain pressure. Traditional sealing assemblies operate on the concept that a bond is formed between the sealing assembly and the case, preventing any movement between the sealing assembly and the case. This results in the shaft rotating within a sealing assembly and creating friction between the shaft and the sealing assembly. Thus, radial sealing assemblies generally require a lubricant in order to operate. A lack of lubricant results in heat generation, contaminant infiltration, radial shaft damage, seal damage and bearing failure.

The maximum operating temperature is one of the most significant factors which must be taken into account when selecting a radial sealing assembly. The maximum operating temperature is a correlation between the shaft speed and the friction which develops between the shaft and the radial sealing assembly. If the maximum operating temperature is exceeded, premature bearing failure may result. If it were possible to decrease or eliminate the concern of operating temperature of a radial sealing assembly, the industry would greatly benefit. While radial sealing assemblies are known in the prior art, there is significant room for improvement, especially in the areas of heat generation and seal wear. The radial sealing assembly disclosed below is an improvement over those known in the art.

### SUMMARY OF THE INVENTION

A shaft sealing assembly for creating a seal between a shaft and a stationary housing comprising: the shaft sealing assembly including a case and a sealing assembly within the case; the case having an inner seal surface diameter within which the shaft is located and within which the sealing assembly located; the case having an outside diameter which may be engaged to the stationary housing; the sealing assembly having an inner seal circumferential surface and an outer seal circumferential surface with the inner seal circumferential surface being engaged to a circumferential surface of the shaft, wherein the sealing assembly remains stationary on the shaft and the outer seal circumferential surface being slidably engaged to the inner seal surface diameter of the case.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1a is an illustration of one embodiment of the present invention.

FIG. 1b is a cross section of Section lines A-A of the upper portion of FIG. 1a.

FIG. 1c is a cross section of Section lines A-A of the lower portion of FIG. 1a.

FIG. 2a is an illustration of one embodiment of the present invention.

FIG. 2b is a cross section of Section lines A-A of the upper portion of FIG. 1a.

FIG. 3 is a cross section of one embodiment of the present invention.

FIG. 4 is a cross section of a sealing assembly of one embodiment of the present invention.

FIG. 5 is a cross section of a case of one embodiment of the present invention.

FIG. 6a is an illustration of a side view of one embodiment of the present invention.

FIG. 6b is an illustration of a top view of one embodiment of the present invention.

FIG. 6c is a perspective view of one embodiment of the present invention.

FIG. 7a is a cross section of one embodiment of the present invention.

FIG. 7b is a cross section of a sealing assembly of one embodiment of the present invention.

FIG. 7c is a cross section of a case of one embodiment of the present invention.

FIG. 8 is a cross section of one embodiment of the present invention installed on a generator.

FIG. 9 is a cross section of one embodiment of the present invention engaged to a shaft.

### DESCRIPTION OF THE INVENTION

Looking to the figures, where like numerals refer to like elements, one can see the instant invention describes a shaft sealing assembly 5 for creating a seal between a shaft 40 and a stationary housing 100. The shaft sealing assembly 5 is comprised of a case 10 and a sealing assembly 50 within the case. The case 10 has an inner seal surface diameter 18 within which the shaft 40 is located and also within which the sealing assembly 50 is located. The case 10 also has an outside diameter 20 which may be engaged to the stationary housing 100. The sealing assembly 50 has an inner seal circumferential surface 75 and an outer seal circumferential surface 80 where the inner seal circumferential surface 75 is engaged to a circumferential surface 42 of the shaft 40 bonding to the shaft 40 and thus remaining stationary on the shaft 40. The outer seal circumferential surface 80 of the sealing assembly 50 is slideably engaged to the inner seal surface diameter 18 of the case 10.

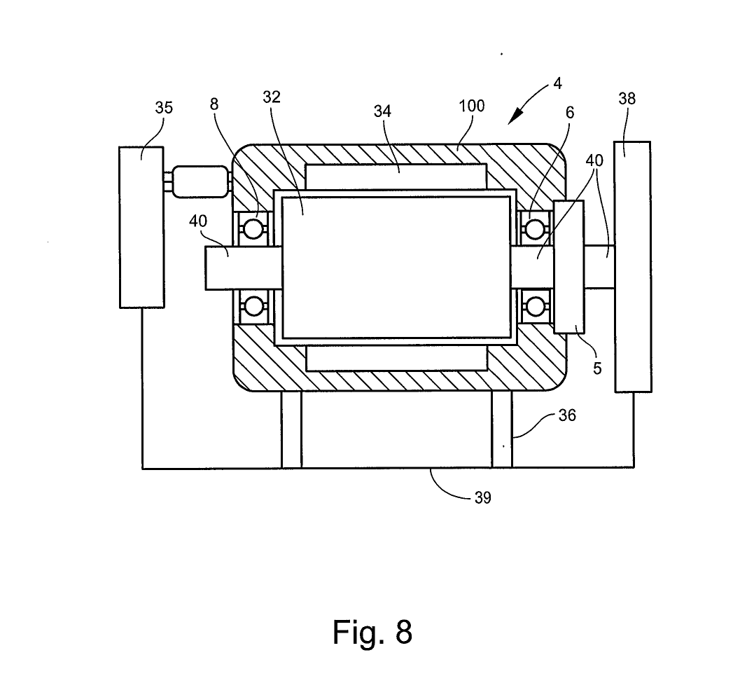

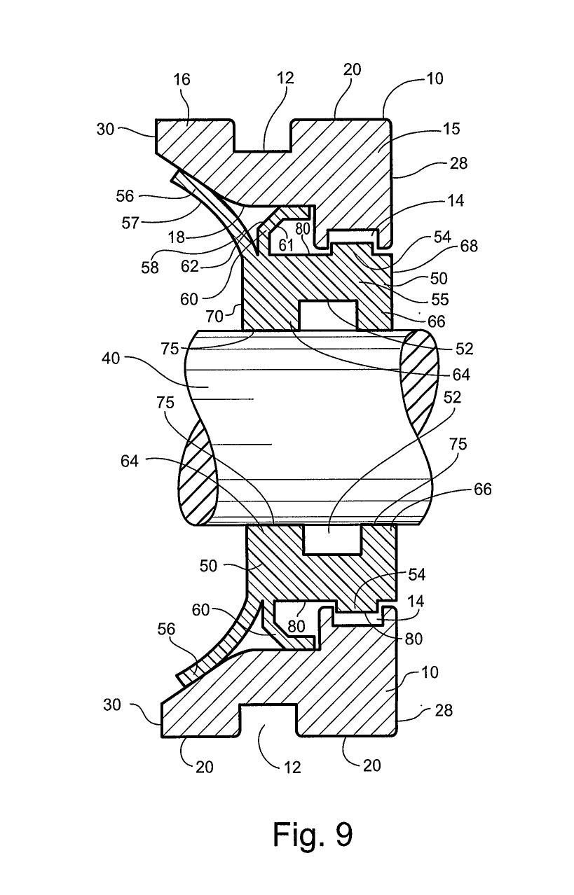

A shaft 40, as used herein, refers to a feature which is integral to nearly all electric generators. Electric generators are known in the art. An electric generator is a device which converts mechanical energy into electrical energy. Examples of devices having shafts on which the instant invention may be used include, but are not limited to, an electric generator, a hydraulic motor or an electric motor. The shaft 40 may also be referred to as a rotating cylindrical shaft or rotatable shaft which has a circumferential surface as illustrated in FIGS. 8 and 9. The shaft essentially rotates or turns in either direction to generate or transfer some form of energy (i.e. mechanical, electrical, etc.). Devices use one or more bearings engaged around in order to provide for free rotation around a fixed axis. The length of time that a shaft 40 and/or a bearing 6, 8 operate effectively is commonly referred to as its shaft life or its bearing life respectively. The shaft life or bearing life is determined by load, temperature, maintenance, lubrication, material defects, contamination, handling, installation and other factors. Shaft sealing assemblies 5 are commonly used to maintain lubrication and prevent contamination of a shaft 40 and/or bearing 6, 8. In one embodiment of the present invention, the shaft 40 rotates in a single direction. In another embodiment, the shaft is a bi-directional shaft. In one embodiment of the present invention, the shaft is 15 centimeters (cm) in diameter or smaller. In another embodiment, the shaft is 12 cm in diameter or smaller. In yet another embodiment, the shaft is 10 cm in diameter or smaller. In still another embodiment, the shaft is 8 cm in diameter or smaller. In yet another embodiment, the shaft is 6 cm in diameter or smaller. In still another embodiment, the shaft is 4 cm in diameter or smaller. In yet another embodiment, the shaft is 3 cm in diameter or smaller. In still another embodiment, the shaft is 2 cm in diameter or smaller. The shaft may be rotating at any speed within its tolerance while the shaft sealing assembly is installed. In one embodiment of the present invention, the shaft may be rotating at a speed of 3500 rpm or less. In another embodiment, the shaft may be rotating at a speed of 3500 rpm to 2500 rpm. In still another embodiment, the shaft may be rotating at a speed of 3000 rpm or less. In yet another embodiment, the shaft may be rotating at a speed of 2500 rpm to 1500 rpm. In still another embodiment, the shaft may be rotating at a speed of 2500 rpm or less. In yet another embodiment, the shaft may be rotating at a speed of 1500 rpm to 500 rpm. In still another embodiment, the shaft may be rotating at a speed of 1000 rpm or less. In yet another embodiment, the shaft may be rotating at a speed of 3500 rpm to 100 rpm.

The stationary housing 100, as used herein, refers to a structure residing around or near a shaft 40. The stationary housing 100 may be used to engage the case 10 of the shaft sealing assembly 5 in order to maintain the shaft sealing assembly 5 in a desired location. The stationary housing 100 may be comprised of any solid material including, but not limited to, a metal, a plastic, a stone, or a combination thereof.

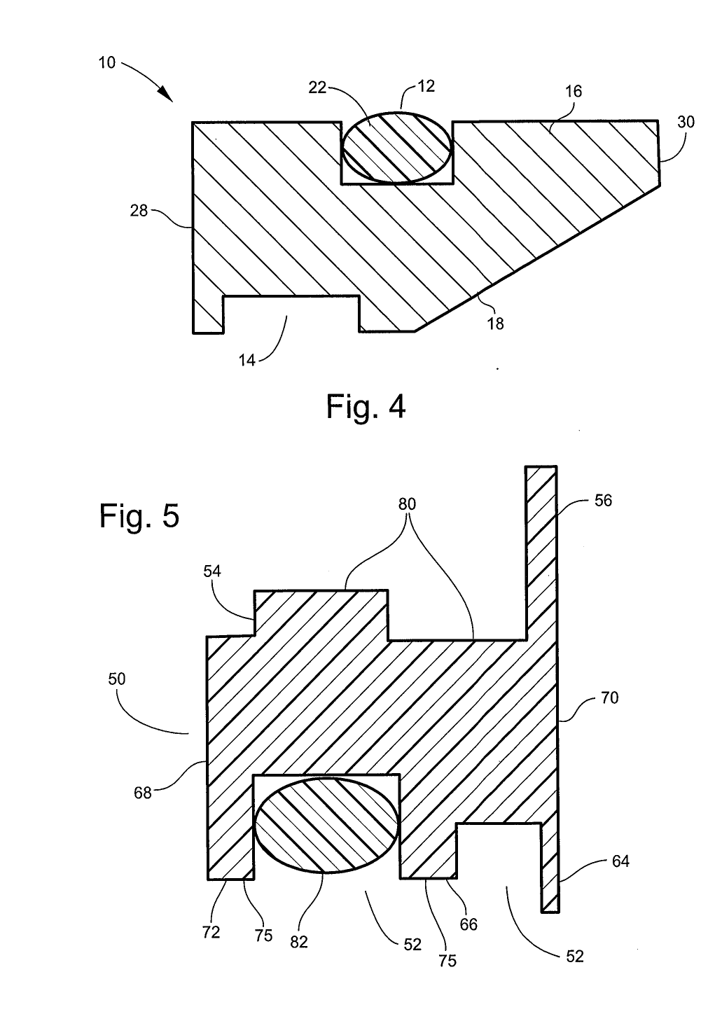

The case 10, as used herein, refers to the outermost structure making up the shaft sealing assembly 5. The case 10 may be described as a rigid structure which has a main body 15, a bore engagement 16, an inner seal surface diameter 18 and an outside diameter 20. The shaft 40, rotating cylindrical shaft or rotatable shaft will be located within the inner seal surface diameter 18 of the case 10. The sealing assembly 50 will also be located and engaged with the inner seal surface diameter 18 of the case 10. The outside diameter 20 of the case is engaged to a stationary housing 100 or some other object in order to maintain the shaft sealing assembly 5 in a desired position and/or location. In one embodiment of the present invention, the case 10 is engaged to a stationary object. Looking to the figures it is illustrated that the case 10 may further include an o-ring groove 12 which is designed to accept an o-ring 22 (FIG. 4). O-rings are known in the art. In one embodiment, an o-ring is a mechanical gasket in the shape of a torus which is made of an elastomeric material. The o-ring has a round cross section and is designed to be seated in a groove 12 and compressed during assembly between two or more parts, creating a seal at the interface between the o-ring and the surface opposite the o-ring groove 12 to which the o-ring is compressed against. The case 10 may further include an engagement groove 14 which is located on the inner seal surface diameter 18. The engagement groove 14 is designed to engage with the sealing assembly 50 and more specifically with an engagement section 54 of a sealing assembly 50. The case 10 may be comprised of a material selected from the group including: carbon steel, stainless steel, aluminum, zinc plated steel, rubber coated steel, a neoprene/aramid composite material, a fluoroelastomer/aramid composite material, or a combination thereof. In one embodiment of the instant invention, the case 10 may be comprised of an inner shell and an outer shell, leaving a hollow space between the inner shell and the outer shell. (Not shown) In another embodiment of the present invention, the case 10 may be comprised of a solid material with no hollow spaces and/or voids within the material. In yet another embodiment of the present invention, the case 10 may further comprise an o-ring groove 12 which is recessed into the outside diameter 20 of the case 10. In still another embodiment, the case may further comprise one or more o-rings 22 as described above, mounted within the o-ring groove 12.

The sealing assembly 50, as used herein, refers to the innermost structure making up the shaft sealing assembly 5. The sealing assembly 50 is located within the case 10. The sealing assembly 50 has an inner seal circumferential surface 75 and an outer seal circumferential surface 80. The shaft 40, rotatable cylindrical shaft 40 or rotatable shaft 40 is located within the sealing assembly 50, engaged to the inner seal circumferential surface 75 of the sealing assembly 50. The sealing assembly 50 is engaged to the shaft 40, rotatable cylindrical shaft or rotatable shaft in such a way as to remain stationary on the surface 42 of the shaft 40, rotatable cylindrical shaft or rotatable shaft, thus generating little to no friction on the circumferential surface 42 or within the shaft 40, rotatable cylindrical shaft 40 or rotatable shaft 40. By generating little to no friction, there is little to no heat generated between the sealing assembly 50 and the shaft 40. The outer seal circumferential surface 80 of the sealing assembly 50 is slidably engaged to the inner seal surface diameter 18 of the case 10. The engagement section 54 of the sealing assembly 5 slidably engages with the engagement groove 14 located on the outer seal circumferential surface 80 of the sealing assembly 5 which permits the sealing assembly 5 to move in a rotational manner, while preventing the sealing assembly 5 from moving in a lateral manner in order to maintain the position of the sealing assembly 5 on the circumferential surface 42 of the shaft 40. In one embodiment of the present invention, no lubrication is required between the sealing assembly 50 and the shaft 40, rotatable cylindrical shaft 40 or rotatable shaft 40. In another embodiment of the present invention, lubrication may be present between the sealing assembly 50 and the shaft 40, rotatable cylindrical shaft 40 or rotatable shaft 40. In yet another embodiment, no lubrication is required between the sealing assembly 50 and the case 10. In still another embodiment, lubrication may be present between the sealing assembly 50 and the case 10. The sealing assembly 50 may be comprised of a variety of materials which are known in the art. In one embodiment of the present invention, the sealing assembly 50 may be comprised of a material selected from the group including a nitrile, a carboxylated nitrile, a hydrogenated nitrile, a fluorocarbon, an ethylene propylene, a polyacrylate, a silicone, a neoprene, a natural rubber, a synthetic rubber, a polytetrafluoroethylene, carbon, graphite, or a combination thereof.

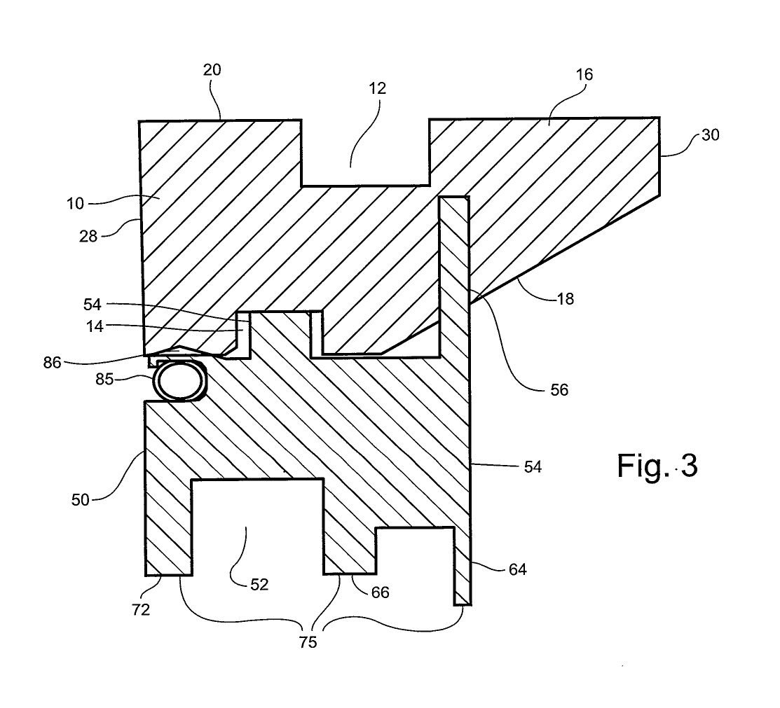

In one embodiment of the present invention, a shaft sealing assembly 5 may further comprise a spring 85 engaged to the sealing assembly 50 in order to increase the surface tension between the sealing assembly 50 and the circumferential surface 42 of the shaft 40. In another embodiment, the spring 85 may be selected from the group including a garter spring, a finger spring, a cantilever spring, a u-spring, a v-spring, or a combination thereof. Looking to FIG. 3, there is illustrated and embodiment of the present invention including a spring 85 engaged to a portion of the sealing assembly 50 and thereby engaging a seal contact 86 with a case 10 and more specifically with the inner seal surface diameter 18 of the case 10.

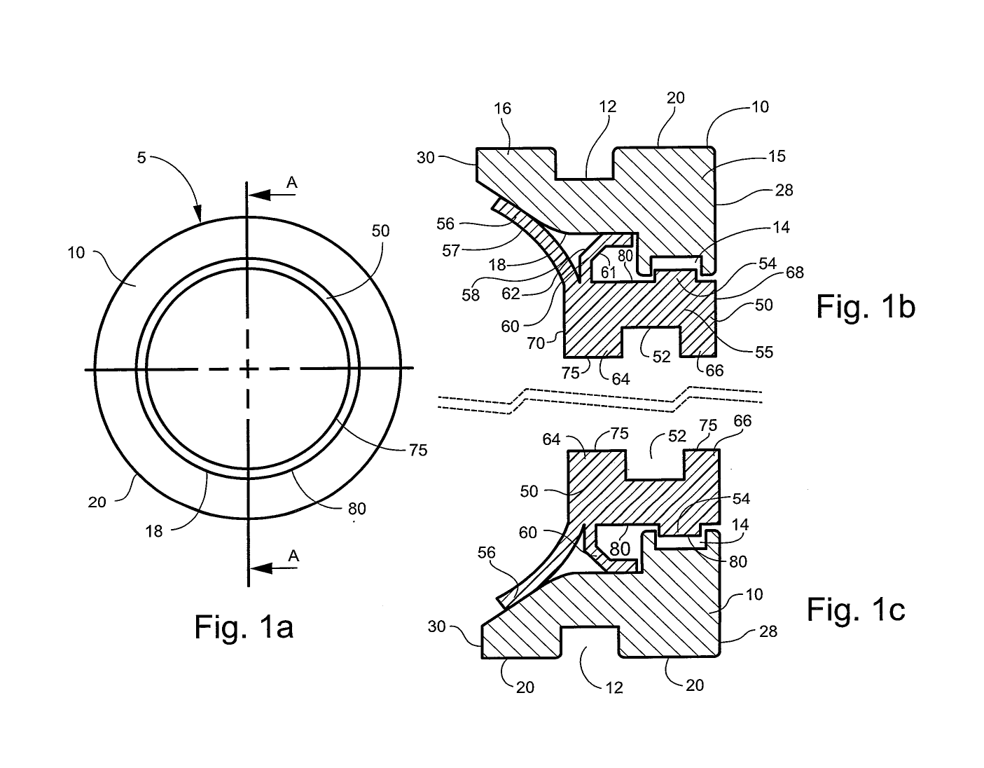

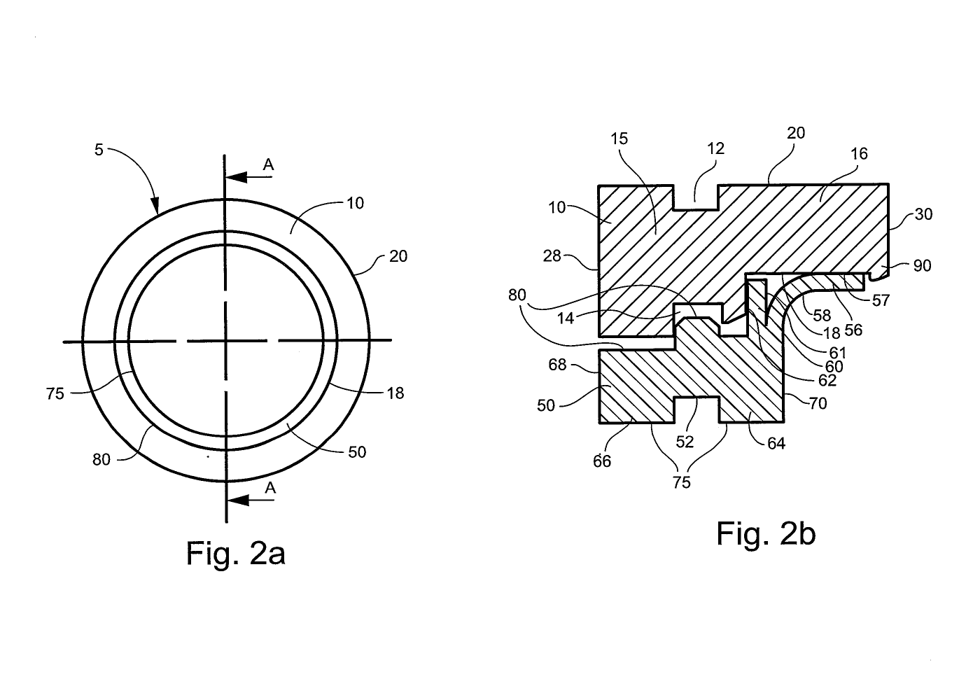

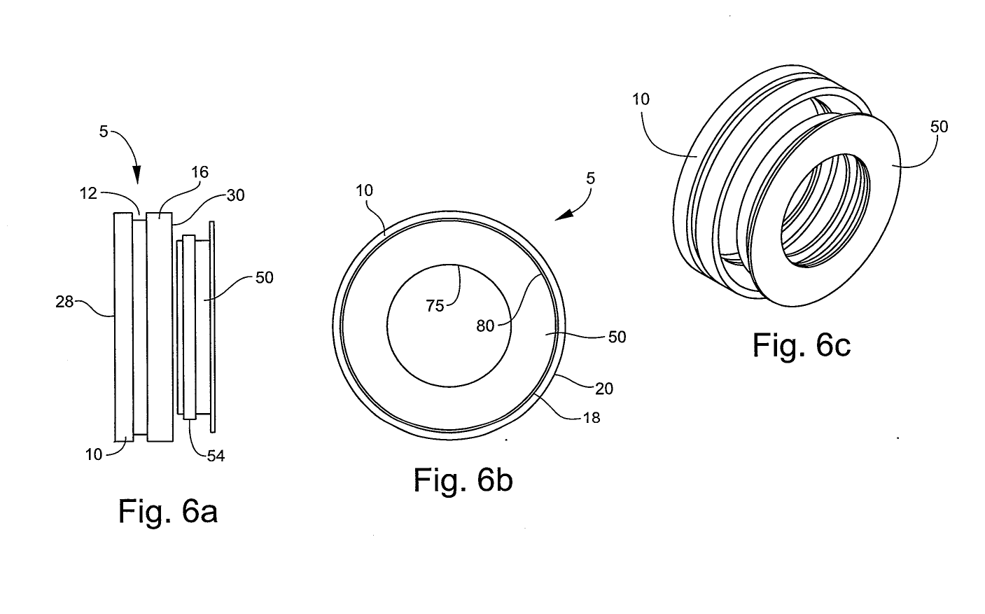

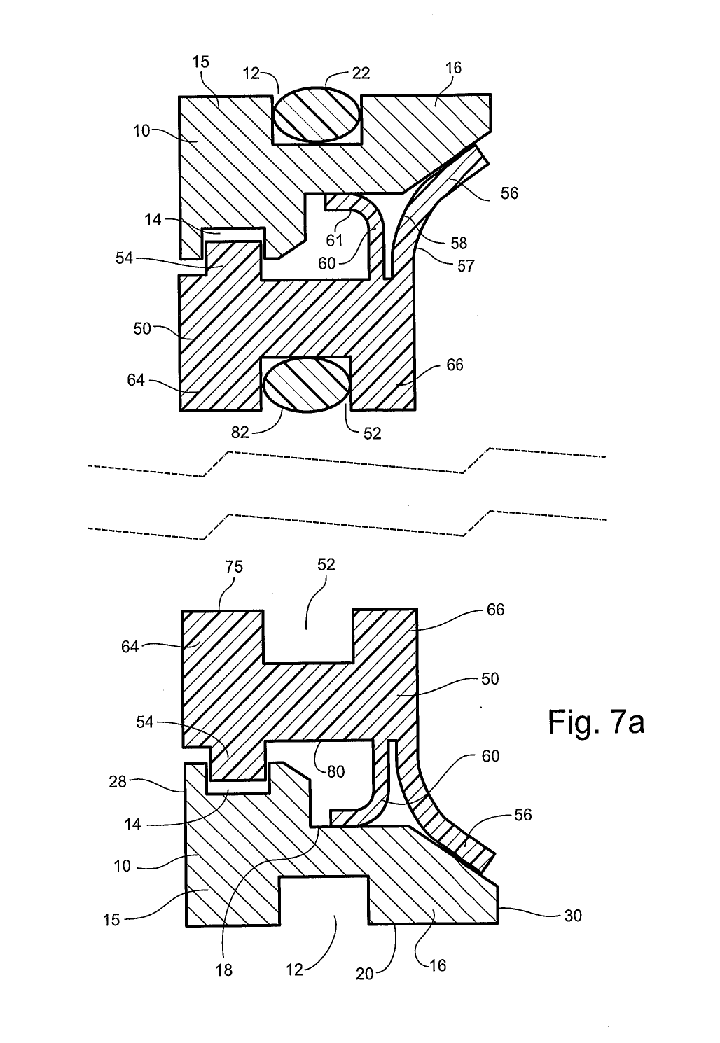

In another embodiment of the present invention, the sealing assembly 50 of the shaft sealing assembly 5 may further comprise an electrically conductive material in order to direct electrical charge in a desired direction or location (i.e., away from the rotor 32, bearings 6, 8, etc.). Electrically conductive materials are known in the art and may include any material having a reasonably high electrical conductivity and also having the ability to divert or direct an electrical charge away from a rotating shaft to an alternate location. By diverting the electrical charge away from the rotating shaft, the shaft should be subjected to less damage and wear as a result. Electrically conductive materials may include, but are not limited to, carbon, graphite, glass, copper, silver, zinc, molybdenum, iron, steel, aluminum, or combinations thereof. In still another embodiment of the present invention, the sealing assembly may further comprise one or more o-ring grooves 52 which are recessed into the inner seal circumferential surface 75 of the sealing assembly 50 and one or more shaft drivers 64, 66, 72 which emanate out from the inner seal circumferential surface 75 of the sealing assembly 50. Shaft drivers 64, 66, 72 engage with and bond to the circumferential surface 42 of the shaft 40. The shaft drivers may be assisted by an o-ring 82 placed into the o-ring groove 52. Once the shaft drivers have bonded to the shaft, they remain immobile on the shaft until the shaft sealing assembly is removed from the shaft or the shaft sealing assembly fails. FIGS. 1b and 1c illustrate one embodiment wherein the sealing assembly has a pair of shaft drivers being the primary shaft driver 66 and the secondary shaft driver 64. FIG. 2b also illustrates an embodiment wherein the sealing assembly has a pair of shaft drivers being the primary shaft driver 66 and the secondary shaft driver 64. FIGS. 3 and 5 illustrate an embodiment of a sealing assembly 50 having a primary 66, secondary 64 and tertiary 72 shaft driver.

In yet another embodiment, the sealing assembly 50 may further comprise one or more o-rings 82 mounted within the o-ring groove 52. The one or more o-rings 82 (as previously described) located in the o-ring groove 52 of the sealing assembly 50 may aid in the formation, maintenance and/or strength of the bond between the sealing assembly 50 and the shaft 40.

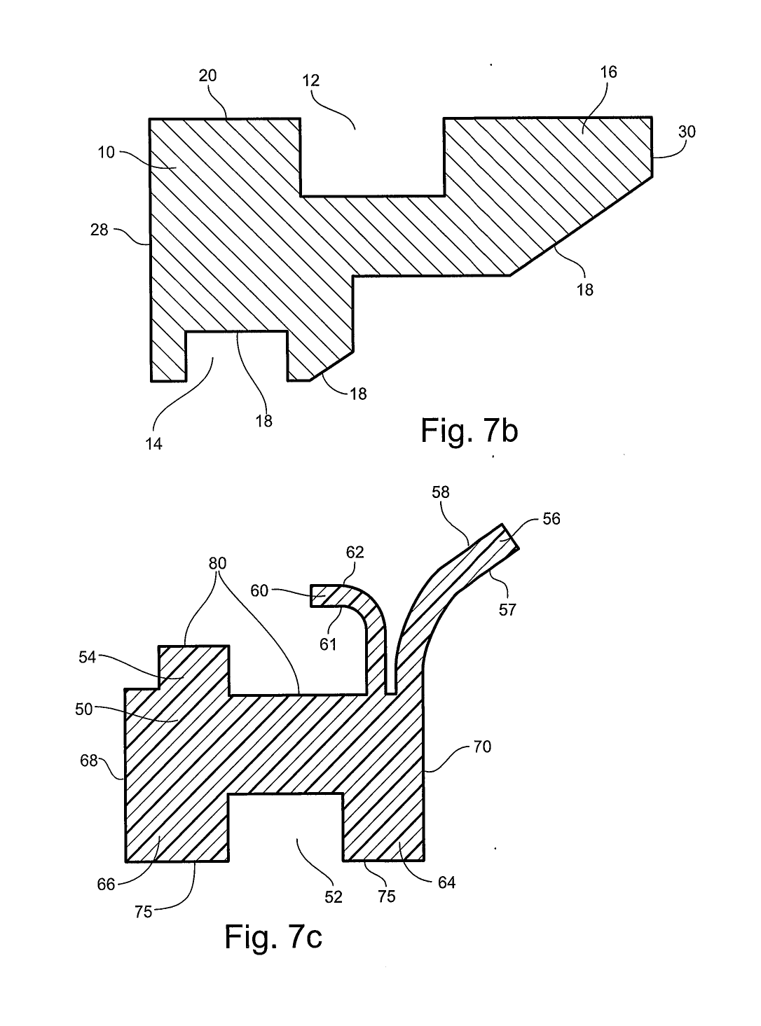

In one embodiment of the present invention, the sealing assembly 50 may further comprise one or more lips 56, 60 which emanate out from the outer seal circumferential surface 80 of the sealing assembly 50. Looking to FIGS. 1b and 1c, there is illustrated an embodiment of a primary lip 56 which includes an inner surface 57 and an outer surface 58. The embodiment also includes a secondary lip 60 with an inner seal lip surface 61 and an outer seal lip surface 62. FIG. 2b illustrates another embodiment of a primary lip 56 which includes an inner surface 57 and an outer surface 58. The embodiment also includes a shorter secondary lip 60 with an inner seal lip surface 61 and an outer seal lip surface 62. FIGS. 3 and 5 illustrate an embodiment of a sealing assembly 50 having only a primary lip 56 including an inner surface 57 and an outer surface 58. Additional embodiments of lips 56, 60 are illustrated in FIGS. 7a and 7c.

In one embodiment of the present invention, the shaft sealing assembly 5 does not generate heat or wear through contact or friction between the inner seal circumferential surface 18 of the sealing assembly 50 and the circumferential surface 42 of the shaft 40 resulting in an increase in shaft 40 life and bearing 6, 8 life.

The relationship and interaction between the sealing assembly 50 and the case 10 is very important in the instant invention. Traditional shaft sealing assemblies maintain do not permit the sealing assembly to rotate within the case, thereby locking the sealing assembly and the case together. This results in a contact point, as it is known in the art, between the inner seal circumferential surface of the sealing assembly and the circumferential surface of the shaft. The contact point, also known as the interface, is the point at which a sealing assembly and the shaft touch. It is at this contact point that a contact band will form as the sealing assembly remains stationary and the shaft rotates within it. The contact band or wear band is a worn path on the circumferential surface of the shaft where it contacts the sealing assembly. The instant invention does not suffer from the problem of contact band development since the sealing assembly 5 of the instant invention bonds to the circumferential surface 42 of a shaft 40 resulting in possible wear to the case 10 only, and not the more valuable shaft 40. The engagement area between the outer seal circumferential surface 80 of the sealing assembly 50 and the inner seal surface diameter 18 of the case 10 allows the sealing assembly 50 to rotate at the same speed as the shaft 40, rotatable cylindrical shaft 40 or rotatable shaft 40. This may result in some friction between the sealing assembly 50 and the case 10 and thus may result in some heat generation between the sealing assembly 50 and the case 10. However, any heat generated is then dissipated outward, away from the shaft 40, bearings 6, 8, and other important components near the shaft 40. Heat is dispersed through the case 10, to the stationary housing 100 and/or to the environment surrounding the shaft 40 sealing assembly 50, away from the shaft 40 on which the shaft sealing assembly 5 is engaged. This helps to prevent any pre-mature wear to the shaft 40. The stationary nature of the engagement area between the circumferential surface 42 of the shaft 40, rotatable cylindrical shaft 40 or rotatable shaft 40 and the inner seal circumferential surface 75 of the sealing assembly 50 also permits the use of a shaft 40 with some degree of imperfection. More precisely, imperfections on the circumferential surface 42 of the shaft 40 may be compensated for due to the immobile nature of the sealing assembly 50 of the instant shaft sealing assembly 5. In one embodiment of the present invention, a shaft sealing assembly 5 may be used on a shaft 40 with a contact band on the shaft's circumferential surface 42.

Looking to FIGS. 1a, 1b and 1c, there is illustrated one embodiment of the present invention. The embodiment includes a case 10 which includes a main body 15 and an O-ring groove 12 into which one or more o-rings 22 may be inserted. The case further includes an engagement groove 14 into which an engagement section 54 of a sealing assembly 50 may be engaged. The case 10 further includes a bore engagement 16 which may engage a stationary housing 100. The case also includes an inner seal surface diameter 18 which is engaged to the sealing assembly 50, an outside diameter 20 which may engage a stationary housing 100, an inner wall 28 and an outer wall 30.

In one embodiment of the present invention, the shaft sealing assembly has a pressure tolerance (i.e. internal pressure and/or external pressure) of less than 120 pounds per square inch (PSI). In another embodiment, the shaft sealing assembly has a pressure tolerance of less than 100 PSI. In yet another embodiment, the shaft sealing assembly has a pressure tolerance of less than 80 PSI. In still another embodiment, the shaft sealing assembly has a pressure tolerance of less than 60 PSI.

The seals disclosed by the instant invention may be used in a wide variety of seal applications. These applications include, but are not limited to, contaminant exclusion, grease retention, oil retention, gas retention and bearing protection. Some specialty seals even combine those functions in order to both retain a gas, liquid or semi-solid material and to exclude a gas, liquid, semi-solid or other unwanted contaminant. The shaft sealing assembly 5 described herein also offers a user the ease of one piece installation. The shaft sealing assembly 5 of the current invention also allows for the use of a lower tolerance bearing 6, 8 to be used in association with a shaft 40 due to the lower heat generation of the shaft sealing assembly 5. The lower tolerance bearings cost less and result in less engine wear and little to no shaft wear. Additionally, the sealing assemblies 50 of the instant invention are designed to run dry, i.e the sealing assemblies 50 are designed to run without any type of lubrication between the shaft 40 and the sealing assembly 50. This is possible since the sealing assembly 50 does not create friction, and thus no heat is generated, with the shaft 40 and instead any friction results between the sealing assembly 50 and the case 10. The shaft sealing assemblies of the current invention are superior to labyrinth seals known in the art due to the current invention's shaft sealing assemblies requiring no lubrication and offering no path for contaminants to penetrate or desired materials to vacate a desired location.

Regarding the temperature tolerance of the current shaft sealing assembly 5, in one embodiment of the present invention, the shaft sealing assembly may operate between a temperature of −10 and 260° C. In another embodiment, the shaft sealing assembly may operate between a temperature of 0 and 260° C. In yet another embodiment, the shaft sealing assembly may operate between a temperature of 0 and 220° C. In still another embodiment, the shaft sealing assembly may operate between a temperature of 0 and 200° C. In yet another embodiment, the shaft sealing assembly may operate between a temperature of 0 and 175° C. In still another embodiment, the shaft sealing assembly may operate between a temperature of 0 and 150° C. In yet another embodiment, the shaft sealing assembly may operate between a temperature of 0 and 125° C. In still another embodiment, the shaft sealing assembly may operate between a temperature of 0 and 100° C.

### DE—Drive End

### ODE—Opposite Drive End

TABLE 1

| | | |
|---|---|---|
| Scope Reading | | |
| Volts | DE Temp (° C.) | ODE Temp (° C.) |

Unit 1

| | | | |
|---|---|---|---|
| 25 | V Discharge | | |
| 8.4 | V Discharge | | |
| 9.2 | V Discharge | | |
| 10 | V Discharge | | |
| 9 | V Discharge | | |
| 11 | V Discharge | 43 | 54 |
| 12.5 | V Discharge | 43 | 53 |
| 14 | V Discharge | 41 | 48 |
| 12 | V Discharge | 42 | 48 |
| 9 | V Discharge | 41 | 45 |

Unit 2

| | | | |
|---|---|---|---|
| 10 | V Noise | | |
| 11.2 | V Discharge | | |
| 11.4 | V Discharge | | |
| 10 | V Noise | | |
| 10 | V Noise | | |
| 9 | V Noise | 43 | 45 |
| 9 | V Noise | 42 | 38 |
| 8 | V Noise | 41 | 39 |
| 9 | V Noise | 40 | 38 |
| 9 | V Noise | 40 | 38 |

FIG. 8 illustrates one embodiment of the present invention showing an electric generator 4 having a shaft 40 with a first bearing 6 and a second bearing 8 mounted onto the shaft 40. The electric generator 4 includes a rotor 32, a stator 34, a drive, 35, a support 36, a load 38 and an electrical ground 39. There is a shaft sealing assembly 5 mounted adjacent to the first bearing 6 in this embodiment in order to provide protection for the bearing and/or retain fluids/gases within the bearing.

The instant invention also includes a method of using a shaft sealing assembly 5 for creating a seal between a shaft 40 and a stationary housing 100 in order to protect one or more components associated with the shaft 40 comprising the steps of:
1. providing a shaft 40;
2. installing the shaft sealing assembly 5 onto the shaft 40, the shaft sealing assembly 50 includes a case 10 and a sealing assembly 50 within the case 10;
   a. the case 10 has an inner seal surface diameter 18 within which the shaft 40 is located and within which the sealing assembly 50 located;
   b. the case 10 has an outside diameter 20;
   c. the sealing assembly 50 has an inner seal circumferential surface 75 and an outer seal circumferential surface 80;
      i. the outer seal circumferential surface 80 being slidably engaged to the inner seal surface diameter 18 of the case 10;
3. engaging the inner seal circumferential surface 75 of the sealing assembly 50 to a circumferential surface 42 of the shaft 40, wherein the sealing assembly 50 remains stationary on the shaft 40;
4. engaging the outside diameter 20 of the case 10 to the stationary housing 100 to ensure that it will remain in a desired position; and
5. rotating the shaft 40 at a speed.

In one embodiment of the above method, the sealing assembly 50 is comprised of a material selected from the group including a nitrile, a carboxylated nitrile, a hydrogenated nitrile, a fluorocarbon, an ethylene propylene, a polyacrylate, a silicone, a neoprene, a natural rubber, a synthetic rubber, a polytetrafluoroethylene, carbon, graphite, or a combination thereof. In another embodiment of the above method, the shaft sealing assembly 5 is used in an electric generator 4, a hydraulic motor or an electric motor.

In one embodiment, the above method further comprises a spring 85 engaged to the sealing assembly 50 in order to increase the surface tension between the sealing assembly 50 and the circumferential surface 42 of the shaft, wherein the spring 85 is selected from the group including a garter spring, a finger spring, a cantilever spring, a u-spring, a v-spring, or a combination thereof. In still another embodiment, the above method further comprises a spring 85 engaged to the sealing assembly 50 in order to increase the surface tension between the sealing assembly 50 and the inner seal surface diameter 18 of the case 10, wherein the spring 85 is selected from the group including a garter spring, a finger spring, a cantilever spring, a u-spring, a v-spring, or a combination thereof (See FIG. 3).

In one embodiment of the above method, the case 10 is comprised of a material selected from the group including: carbon steel, stainless steel, aluminum, zinc plated steel, rubber coated steel, a neoprene/aramid composite material, a fluoroelastomer/aramid composite material, or a combination thereof. In another embodiment of the above method, the sealing assembly 50 of the shaft sealing assembly 5 further comprises an electrically conductive material in order to direct electrical charge in a desired direction or location (i.e., away from the rotor and/or bearings). In still another embodiment of the above method, the sealing assembly 50 of the shaft sealing assembly 5 further comprising one or more o-ring grooves 52 which are recessed into the inner seal circumferential surface 75 of the sealing assembly 50 and one or more shaft drivers 64, 66, 72 which emanate out from the inner seal circumferential surface 75 of the sealing assembly 50, and further comprises one or more o-rings 82 mounted within the o-ring groove 52 which are engaged with the circumferential surface 42 of the shaft 40.

In one embodiment of the above method the sealing assembly 50 of the shaft sealing assembly 5 further comprises one or more lips 56, 60 which emanate out from the outer seal circumferential surface 80 of the sealing assembly 50. In another embodiment of the above method, the case 10 of the shaft sealing assembly 5 further comprising an o-ring groove 12 which is recessed into the outside diameter 20 of the case 10, and further comprises one or more o-rings 22 mounted within the o-ring groove 12 which are engaged to the stationary housing 100 to ensure that the shaft sealing assembly 5 will remain in a desired position. In yet another embodiment of the above method, the shaft sealing assembly 5 does not generate heat through contact or friction between the inner seal circumferential surface 75 of the sealing assembly 50 and the circumferential surface 42 of the shaft 40 resulting in an increase in shaft life and bearing life.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

The present invention may be embodied in other forms without departing from the spirit and the essential attributes thereof, and, accordingly, reference should be made to the appended claims, rather than to the foregoing specification, as indicating the scope of the invention. Additionally, the invention illustratively disclosed herein suitably may be practiced in the absence of any element which is not specifically disclosed herein.

I claim:

1. A shaft sealing assembly for creating a seal between a shaft and a stationary housing comprising:
said shaft sealing assembly including a case and a sealing assembly within said case;
said case having an inner seal surface diameter within which said shaft is located and within which said sealing assembly located;
said case having an outside diameter which may be engaged to said stationary housing;
said sealing assembly having an inner seal circumferential surface and an outer seal circumferential surface;
said inner seal circumferential surface being engaged to a circumferential surface of said shaft, wherein said sealing assembly remains stationary on said shaft; and
said outer seal circumferential surface being slideably engaged to the inner seal surface diameter of said case.

2. The shaft sealing assembly of claim 1 wherein said sealing assembly being comprised of a material selected from the group including a nitrile, a carboxylated nitrile, a hydrogenated nitrile, a fluorocarbon, an ethylene propylene, a polyacrylate, a silicone, a neoprene, a natural rubber, a synthetic rubber, a polytetrafluoroethylene, carbon, graphite, or a combination thereof.

3. The shaft sealing assembly of claim 1 wherein said shaft sealing assembly is used on a shaft associated with an electric generator, a hydraulic motor or an electric motor.

4. The shaft sealing assembly of claim 1 further comprising a spring engaged to said sealing assembly in order to increase the surface tension between said sealing assembly and the circumferential surface of said shaft;
wherein said spring being selected from the group including a garter spring, a finger spring, a cantilever spring, a u-spring, a v-spring, or a combination thereof.

5. The shaft sealing assembly of claim 1 wherein said case being comprised of a material selected from the group including: carbon steel, stainless steel, aluminum, zinc plated steel, rubber coated steel, a neoprene/aramid composite material, a fluoroelastomer/aramid composite material, or a combination thereof.

6. The shaft sealing assembly of claim 1 wherein said sealing assembly of said shaft sealing assembly further comprising an electrically conductive material in order to direct electrical charge in a desired direction or location (i.e., away from the rotor and/or bearings).

7. The shaft sealing assembly of claim 1 wherein said sealing assembly of said shaft sealing assembly further comprising one or more o-ring grooves which are recessed into the inner seal circumferential surface of said sealing assembly and one or more shaft drivers which emanate out from the inner seal circumferential surface of said sealing assembly; and
further comprising one or more o-rings mounted within said o-ring grooves.

8. The shaft sealing assembly of claim 1 wherein said sealing assembly of said shaft sealing assembly further comprising one or more lips which emanate out from the outer seal circumferential surface of said sealing assembly.

9. The shaft sealing assembly of claim 1 wherein said case of said shaft sealing assembly further comprising an o-ring groove which is recessed into the outside diameter of said case; and
further comprising one or more o-rings mounted within said o-ring grooves.

10. The shaft sealing assembly of claim 1 wherein the shaft sealing assembly does not generate heat through contact or friction between the inner seal circumferential surface of the sealing assembly and the circumferential surface of said shaft resulting in an increase in shaft life and bearing life.

11. A method of using a shaft sealing assembly for creating a seal between a shaft and a stationary housing in order to protect one or more components associated with the shaft comprising the steps of:
providing a shaft;
installing said shaft sealing assembly onto said shaft, said shaft sealing assembly includes a case and a sealing assembly within said case;
said case has an inner seal surface diameter within which said shaft is located and within which said sealing assembly located;
said case having an outside diameter;
said sealing assembly having an inner seal circumferential surface and an outer seal circumferential surface;
said outer seal circumferential surface being slideably engaged to the inner seal surface diameter of said case;
engaging said inner seal circumferential surface of said sealing assembly to a circumferential surface of said shaft, wherein said sealing assembly remains stationary on said shaft;
engaging the outside diameter of said case to said stationary housing to ensure that it will remain in a desired position; and
rotating said rotatable shaft at a speed.

12. The method of claim 11 wherein said sealing assembly being comprised of a material selected from the group including a nitrile, a carboxylated nitrile, a hydrogenated nitrile, a fluorocarbon, an ethylene propylene, a polyacrylate, a silicone, a neoprene, a natural rubber, a synthetic rubber, a polytetrafluoroethylene, carbon, graphite, or a combination thereof.

13. The method of claim 11 wherein said shaft sealing assembly is used in an electric generator, a hydraulic motor or an electric motor.

14. The method of claim 11 further comprising a spring engaged to said sealing assembly in order to increase the surface tension between said sealing assembly and the circumferential surface of said shaft;
wherein said spring being selected from the group including a garter spring, a finger spring, a cantilever spring, a u-spring, a v-spring, or a combination thereof.

15. The method of claim 11 wherein said case being comprised of a material selected from the group including: carbon steel, stainless steel, aluminum, zinc plated steel, rubber coated steel, a neoprene/aramid composite material, a fluoroelastomer/aramid composite material, or a combination thereof.

16. The method of claim 11 wherein said sealing assembly of said shaft sealing assembly further comprising an electrically conductive material in order to direct electrical charge in a desired direction or location (i.e., away from the rotor and/or bearings).

17. The method of claim 11 wherein said sealing assembly of said shaft sealing assembly further comprising one or more o-ring grooves which are recessed into the inner seal circumferential surface of said sealing assembly and one or more shaft drivers which emanate out from the inner seal circumferential surface of said sealing assembly; and
further comprising one or more o-rings mounted within said o-ring grooves which are engaged with the circumferential surface of said shaft.

18. The shaft sealing assembly of claim 11 wherein said sealing assembly of said shaft sealing assembly further comprising one or more lips which emanate out from the outer seal circumferential surface of said sealing assembly.

19. The method of claim 11 wherein said case of said shaft sealing assembly further comprising an o-ring groove which is recessed into the outside diameter of said case; and
further comprising one or more o-rings mounted within said o-ring grooves which are engaged to said stationary housing to ensure that it will remain in a desired position.

20. The method of claim 11 wherein the shaft sealing assembly does not generate heat through contact or friction between the inner seal circumferential surface of the sealing assembly and the circumferential surface of said shaft resulting in an increase in shaft life and bearing life.
